(19) United States
(12) Patent Application Publication
(10) Pub. No.: US 2018/0178322 A1
(43) Pub. Date: Jun. 28, 2018

(54) LASER PROCESSING DEVICE AND LASER PROCESSING METHOD

(71) Applicant: METAL INDUSTRIES RESEARCH & DEVELOPMENT CENTRE, Kaohsiung City 811 (TW)

(72) Inventors: Yu-Ting Lu, Kaohsiung City (TW); Chao-Yung Yeh, Kaohsiung City (TW); Chiu-Feng Lin, Pingtung County (TW); Ying-Cheng Lu, Kaohsiung City (TW)

(21) Appl. No.: 15/392,601

(22) Filed: Dec. 28, 2016

(51) Int. Cl. B23K 26/06; G02B 19/00; G02B 27/09

(52) U.S. Cl. CPC B23K 26/0648; G02B 27/0927; G02B 19/0047; G02B 19/0028

(57) ABSTRACT

A laser process device includes a processing machinery for processing a workpiece, a laser source for emitting a laser beam to the workpiece and a modulating lens group. The modulating lens group can selectively modulate the laser beam for laser processing the workpiece respectively, like pre-heating, forming process or post treatment, so the modulating lens group can improve process efficiency of the processing machinery.

### TECHNICAL FIELD

This disclosure relates to a laser processing device and a laser processing method, particularly relates to a laser processing device and a laser processing method using modulating lens group to modulate laser beam selectively for different laser processing processes.

### BACKGROUND OF THE DISCLOSURE

Workpiece is cut (e.g., turning or milling) by cutting tool of processing machinery in conventional cutting process. However, the cutting tool is easy to be abraded during cutting process to lower life cycle of machinery and cutting efficiency when the workpiece is made of difficult-to-machine material (like ceramics or superalloy), and product precision is not easy to control. So how to improve cutting efficiency of the processing machinery and product precision is an important development object.

### SUMMARY

A laser processing device of the present disclosure comprises a processing machinery for processing a workpiece, a laser source installed on the processing machinery for emitting a laser beam, and a modulating lens group including a focus component, wherein the focus component is disposed in a light path of the laser beam.

The primary object of the present disclosure is to switch different components of the modulating lens group for selectively modulating laser beam, so the laser beam focused on a workpiece can be applied for different processes, like pre-heating, forming process or post treatment.

When a focus component of the modulating lens group is disposed in the light path of the laser beam, the focus component can focus the laser beam on the workpiece for pre-heating.

When a focus component and a focal variation component of the modulating lens group are disposed in the light path of the laser beam, the focal variation component can modulate the focal length of the laser beam, and the focus component can focus the laser beam after focal length modulation on the workpiece for forming process (e.g., scribing, cutting or engraving).

When a focus component, a focal variation component and a homogenization component are disposed in the light path of the laser beam, the homogenization component can homogenize the laser beam intensity after the focal variation component modulates the focal length of the laser beam, and finally the focus component can focus the laser beam after focal length modulation and intensity homogenization on the workpiece for post treatment (e.g., heat treatment or surface finish).

### DESCRIPTION OF THE DRAWINGS

FIG. 1 is a flow chart illustrating a laser processing method in accordance with an embodiment of the present disclosure.

FIG. 2 is a partial section view diagram illustrating a laser processing device in accordance with a first embodiment of the present disclosure.

FIG. 3a is a schematic diagram illustrating a laser source and a modulating lens group in accordance with the first embodiment of the present disclosure.

FIG. 3b is a schematic diagram illustrating the modulating lens group in accordance with the first embodiment of the present disclosure.

FIG. 4a is a schematic diagram illustrating a laser source and a modulating lens group in accordance with second embodiment of the present disclosure.

FIG. 4b is a schematic diagram illustrating the modulating lens group in accordance with the second embodiment of the present disclosure.

FIG. 5a is a schematic diagram illustrating a laser source and a modulating lens group in accordance with third embodiment of the present disclosure.

FIG. 5b is a schematic diagram illustrating the modulating lens group in accordance with the third embodiment of the present disclosure.

### DETAILED DESCRIPTION

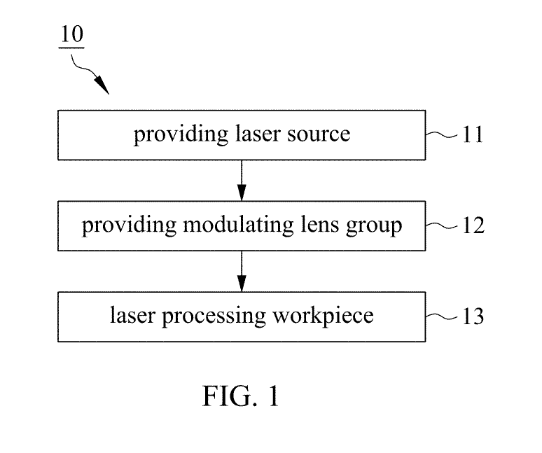

With reference to FIG. 1, a laser processing method 10 comprises step 11 of providing laser source, step 12 of providing modulating lens group and step 13 of laser processing workpiece. A laser processing device 100 is used to process a workpiece 200 in the laser processing method 10, wherein the laser processing device 100 includes a processing machinery 110 used for processing the workpiece 200, a laser source 120 and a modulating lens group 130.

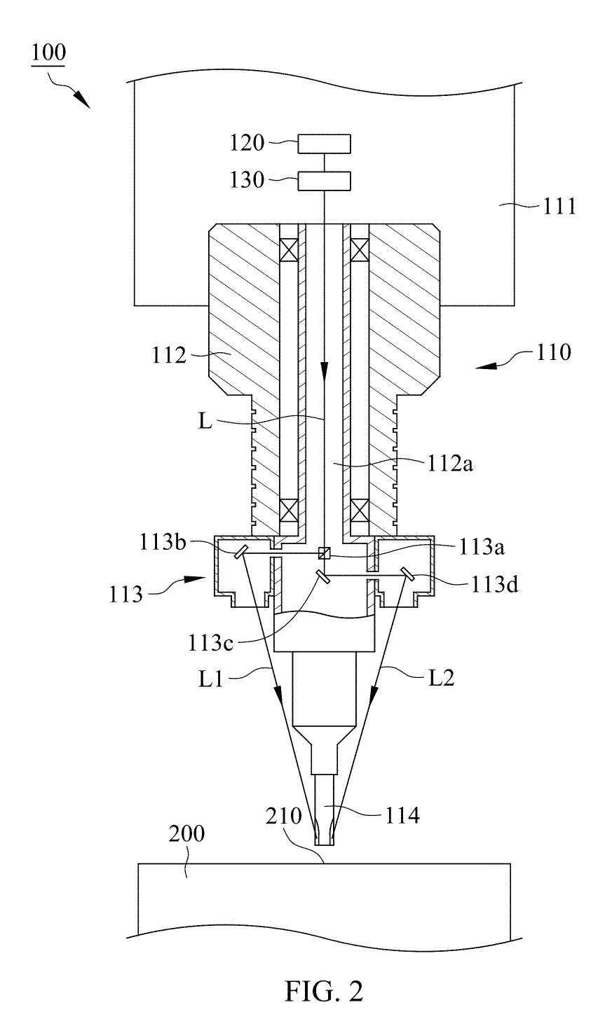

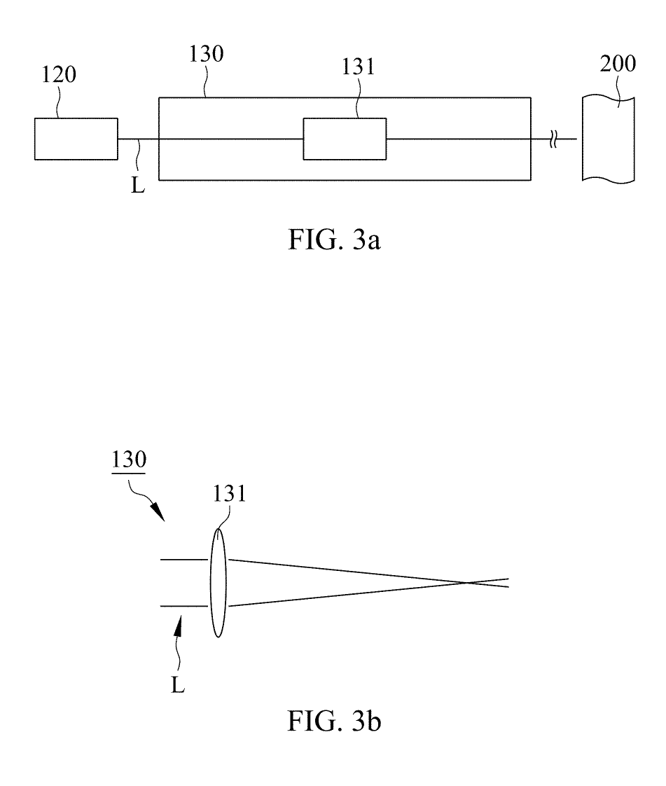

With reference to FIGS. 1 and 2, the laser source 120 is provided in step 11, wherein the laser source 120 is installed on the processing machinery 110 and used for emitting a laser beam L to the workpiece 200. Then the modulating lens group 130 is provided in step 12, wherein the modulating lens group 130 is installed between the laser source 120 and the workpiece 200. With reference to FIGS. 3a and 3b, the modulating lens group 130 includes a focus component 131 in first embodiment of the present disclosure, wherein the focus component 131 is disposed in a light path of the laser beam L, and the focus component 131 is a long-focus lens preferably.

With reference to FIGS. 1, 2, 3a and 3b, the workpiece 200 is processed by the laser beam L in step 13. The focus component 131 of the modulating lens group 130 is used to focus the laser beam L on the workpiece 200 for pre-heating when the laser beam L passes through the focus component 131. Preferably, the laser source 120 is a quasi-continuous wave (QCW) laser which can be operated in CW (continuous wave) mode or pulse mode. In this embodiment, the laser source 120 is operated in CW mode to emit the laser beam L to the workpiece 200 for pre-heating the workpiece 200.

With reference to FIG. 2, the processing machinery 110 preferably includes a main body 111, a hollow shaft 112, a beam splitting group 113 and a cutting tool 114 used for processing (turning or milling) the workpiece 200, wherein the laser source 120 and the modulating lens group 130 are installed on the main body 111, and the hollow shaft 112 is located between the main body 111 and the cutting tool 114. In this embodiment, the cutting tool 114 is used for cutting a region to be processed 210 of the workpiece 200, wherein the processing machinery 110 drives the hollow shaft 112 rotating by a driver (not shown in drawing), and the hollow shaft 112 drives the cutting tool 114 to rotate simultaneously for cutting the region to be processed 210. The hollow shaft 112 has a passage 112a, and the beam splitting group 113 is disposed in the passage 112a. The beam splitting group 113 is used to split the laser beam L into a first laser sub-beam L1 and a second laser sub-beam L2, and makes the first laser sub-beam L1 and the second laser sub-beam L2 respectively focusing on same or different positions of the same plane of the region to be processed 210 for pre-heating and softening the workpiece 200 evenly, to improve processing efficiency and precision of the region to be processed 210.

With reference to FIG. 2, the beam splitting group 113 preferably includes a beam splitter 113a, a first reflector 113b, a second reflector 113c and a third reflector 113d, wherein the beam splitter 113a and the second reflector 113c are disposed in the light path of the laser beam L, and the first reflector 113b and the third reflector 113d are respectively disposed on the both sides of the beam splitter 113a. The beam splitter 113a is used for splitting the laser beam L into the first laser sub-beam L1 and the second laser sub-beam L2. The first laser sub-beam L1 is reflected to the first reflector 113b from the beam splitter 113a, and then reflected from the first reflector 113b to the region to be processed 210 for pre-heating and softening. The second laser sub-beam L2 is transmitted toward the second reflector 113c after penetrating through the beam splitter 113a, and reflected to the third reflector 113d from the second reflector 113c, and then reflected from the third reflector 113d to the region to be processed 210 for pre-heating and softening. In this embodiment, the first reflector 113b, the second reflector 113c and the third reflector 113d are total-reflection lenses.

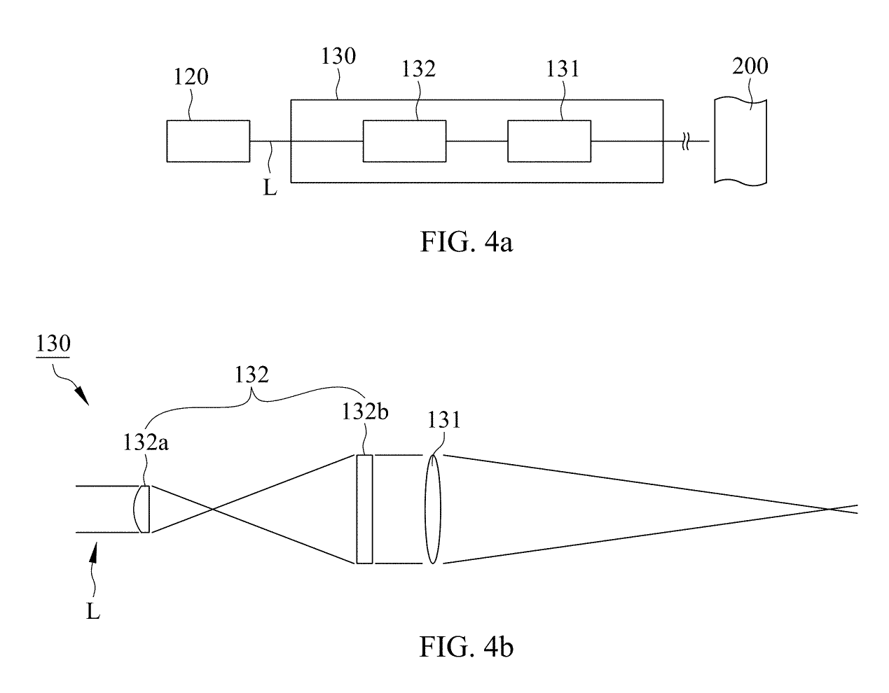

With reference to FIGS. 2, 4a and 4b, a laser processing device 100 of second embodiment of the present disclosure includes a processing machinery 110, a laser source 120 and a modulating lens groups 130. The laser source 120 is used for emitting a laser beam L, wherein the laser beam L can pass through the processing machinery 110 for processing a workpiece 200. The modulating lens group 130 is installed between the laser source 120 and the workpiece 200, wherein the modulating lens group 130 includes a focus component 131 and a focal variation component 132. The focus component 131 and the focal variation component 132 are both disposed in the light path of the laser beam L, and the focal variation component 132 is located between the laser source 120 and the focus component 131.

With reference to FIGS. 1, 4a and 4b, when the laser beam L passes through the focal variation component 132 and the focus component 131 sequentially in step 13, the focal variation component 132 is used for modulating the focal length of the laser beam L, and the focus component 131 is used for focusing the laser beam L after focal length modulation on the workpiece 200 for forming process. Preferably, the workpiece 200 can be scribed, cut or engraved in the forming process. In this embodiment, the laser source 120 is operated in pulse mode to emit the laser beam L to the workpiece 200 for the forming process.

With reference to FIGS. 4a and 4b, the focus component 131 is a long-focus lens and the focal variation component 132 includes a plano-convex lens 132a and a flat lens 132b in this embodiment, wherein the flat lens 132b is located between the plano-convex lens 132a and the focus component 131. The focal variation component 132 can module the spot size and focal length of the laser beam L and expand the beam diameter of the laser beam L by the plano-convex lens 132a and the flat lens 132b, so the laser beam L after focal length modulation can be focused on the workpiece 200 by the focus component 131 for the forming process.

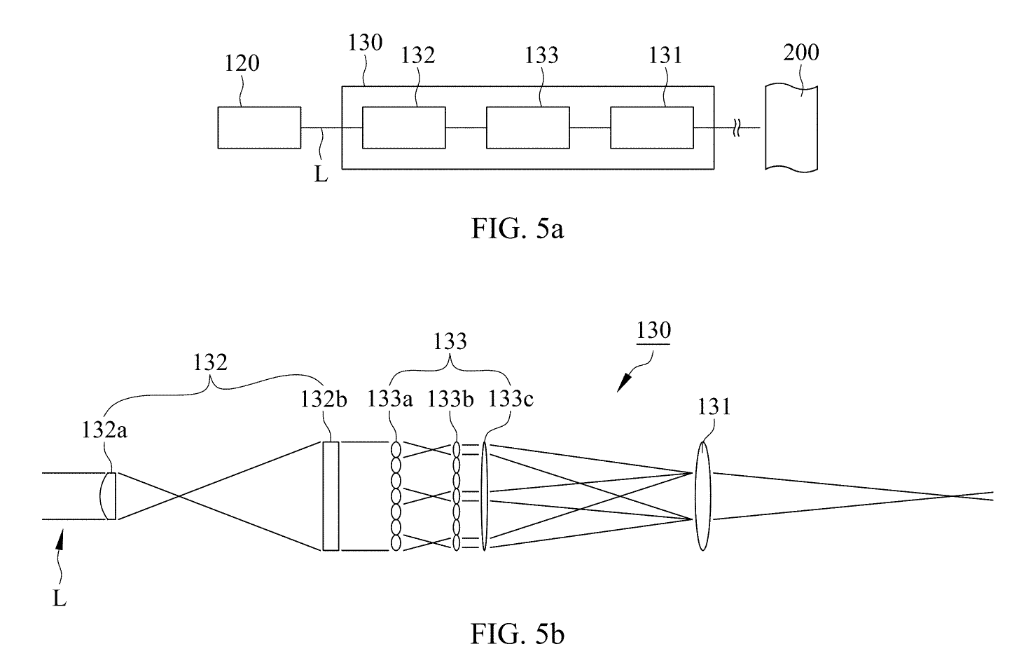

With reference to FIGS. 2, 5a and 5b, a laser processing device 100 of third embodiment of the present disclosure includes a processing machinery 110 used for processing a workpiece 200, a laser source 120 and a modulating lens groups 130, wherein the laser source 120 is used for emitting a laser beam L to the workpiece 200, and the modulating lens group 130 is installed between the laser source 120 and the workpiece 200. The modulating lens group 130 includes a focus component 131, a focal variation component 132 and a homogenization component 133, wherein the homogenization component 133 is located between the focal variation component 132 and the focus component 131, and the focus component 131, the focal variation component 132 and the homogenization component 133 are all disposed in the light path of the laser beam L.

With reference to FIGS. 1, 5a and 5b, when the laser beam L passes through the focal variation component 132, the homogenization component 133 and the focus component 131 sequentially in step 13, the focal variation component 132 is used for modulating the focal length of the laser beam L firstly, then the homogenization component 133 is used for homogenizing intensity of the laser beam L after focal length modulation, and finally the focus component 131 is used for focusing the laser beam L after intensity homogenization on the workpiece 200 for post treatment. Preferably, the post treatment is heat treatment or surface finish.

A uniform light spot can be obtained on the workpiece 200 when the focus component 131 focus the laser beam L after focal length modulation and intensity homogenization, wherein the uniform light spot can enhance the strength of the workpiece 200 through heat treatment, or decrease the surface roughness of the workpiece 200 through surface finish. Preferably, the laser source 120 can be operated in CW mode to emit the laser beam L to the workpiece 200 for heat treatment, or operated in pulse mode to emit the laser beam L to the workpiece 200 for surface finish.

With reference to FIGS. 5a and 5b, the focal variation component 132 includes a plano-convex lens 132a and a flat lens 132b in this embodiment, wherein the flat lens 132b is located between the plano-conves lens 132a and the homogenization component 133. The focal variation component 132 can module the spot size and the focal length of the laser beam L and expand the beam diameter of the laser beam L for into the homogenization component 133 by the plano-convex lens 132a and the flat lens 132b.

With reference to FIGS. 5a and 5b, the homogenization component 133 includes a first microlens array 133a, a second microlens array 133b and a Fourier lens 133c, wherein the second microlens array 133b is located between the first microlens array 133a and the Fourier lens 133c. The first microlens array 133a is adjacent to the flat lens 132b of the focal variation component 132, and the Fourier lens 133c is adjacent to the focus component 131. The first microlens array 133 a and the second microlens array 133b can transform the laser beam L after focal length modulation into a plurality of parallel beams, and the parallel beams can pass through the Fourier lens 133c and overlap with each other on the focus component 131. And finally the focus component 131 can focus the overlap beams on the workpiece 200 to produce the uniform light spot for heat treatment or surface finish, wherein the focus component 131 is a long-focus lens preferably.

The laser processing device 100 of the present disclosure can switch the focus component 131, the focal variation component 132 and the homogenization component 133 of the modulating lens group 130 to modulate the laser beam L selectively, and can integrate different light path systems into an adjustable light path for applying to different processing processes. Single laser source can be used for pre-heating (softening), forming process (scribing, cutting or engraving) and post treatment (heat treatment or surface finish) respectively, hence the process efficiency can be enhanced and the operation time of station transfer for different processes can be reduced.

While this disclosure has been particularly illustrated and described in detail with respect to the preferred embodiments thereof, it will be clearly understood by those skilled in the art that is not limited to the specific features shown and described and various modified and changed in form and details may be made without separation from the spirit and scope of this disclosure.

What is claimed is:

1. A laser processing device comprising:
a processing machinery for processing a workpiece;
a laser source for emitting a laser beam; and
a modulating lens group including a focus component, wherein the focus component is disposed in a light path of the laser beam.

2. The laser processing device in accordance with claim 1, wherein the modulating lens group further includes a focal variation component, the focal variation component is disposed in the light path of the laser beam and located between the laser source and the focus component.

3. The laser processing device in accordance with claim 2, wherein the modulating lens group further includes a homogenization component, the homogenization component is disposed in the light path of the laser beam and located between the focal variation component and the focus component.

4. The laser processing device in accordance with claim 1, wherein the focus component is a long-focus lens.

5. The laser processing device in accordance with claim 2, wherein the focal variation component includes a plano-convex lens and a flat lens, and the flat lens is located between the plano-convex lens and the focus component.

6. The laser processing device in accordance with claim 3, wherein the homogenization component includes a first microlens array, a second microlens array and a Fourier lens, and the second microlens array is located between the first microlens array and the Fourier lens.

7. The laser processing device in accordance with claim 1, wherein the laser source is installed on the processing machinery.

8. The laser processing device in accordance with claim 1, wherein the modulating lens group is installed between the laser source and the workpiece.

9. The laser processing device in accordance with claim 1, wherein the laser source is a quasi-continuous wave (QCW) laser.

10. A laser processing method comprising:
providing a laser source, wherein the laser source is used for emitting a laser beam;
providing a modulating lens group, wherein the modulating lens group includes a focus component; and
laser processing a workpiece, wherein the focus component is used for focusing the laser beam on the workpiece for pre-heating when the laser beam passes through the focus component.

11. The laser processing method in accordance with claim 10, wherein the modulating lens group further includes a focal variation component located between the laser source and the focus component, and wherein the focal variation is used for modulating focal length of the laser beam and the focus component is used for focusing the laser beam after focal length modulation on the workpiece for forming process when the laser beam passes through the focal variation component and the focus component sequentially.

12. The laser processing method in accordance with claim 11, wherein the modulating lens group further includes a homogenization component located between the focal variation component and the focus component, and wherein the homogenization component is used for homogenizing intensity of the laser beam after focal length modulation, and the focus component is used for focusing the laser beam after intensity homogenization on the workpiece for post treatment when the laser beam passes through the focal variation component, the homogenization component and the focus component sequentially.

13. The laser processing method in accordance with claim 10, wherein the focus component is a long-focus lens.

14. The laser processing method in accordance with claim 11, wherein the focal variation component includes a plano-convex lens and a flat lens, and the flat lens is located between the plano-convex lens and the focus component.

15. The laser processing method in accordance with claim 12, wherein the homogenization component includes a first microlens array, a second microlens array and a Fourier lens, and the second microlens array is located between the first microlens array and the Fourier lens.

16. The laser processing method in accordance with claim 10, wherein the laser source is installed on a processing machinery which is used for processing the workpiece.

17. The laser processing method in accordance with claim 10, wherein the modulating lens group is installed between the laser source and the workpiece.

18. The laser processing method in accordance with claim 10, wherein the laser source is a quasi-continuous wave (QCW) laser.
